(19) United States
(12) Patent Application Publication
(10) Pub. No.: US 2026/0309480 A1
(43) Pub. Date: Oct. 8, 2026

(54) SYSTEM FOR MEASURING OPTICAL PULSE TIME-OF-FLIGHT

(71) Applicant: KOREA ADVANCED INSTITUTE OF SCIENCE AND TECHNOLOGY, Daejeon (KR)

(72) Inventors: Jungwon KIM, Daejeon (KR); Hyoungsu CHOI, Daejeon (KR)

(73) Assignee: KOREA ADVANCED INSTITUTE OF SCIENCE AND TECHNOLOGY, Daejeon (KR)

(21) Appl. No.: 19/637,070

(22) Filed: Apr. 2, 2026

(30) Foreign Application Priority Data
Apr. 3, 2025 (KR) 10-2025-0043284
Oct. 1, 2025 (KR) 10-2025-0143685

(51) Int. Cl. G01B 11/06

(52) U.S. Cl. CPC G01B 11/06

(57) ABSTRACT

A system for measuring a thickness of an object is provided. The system includes an optical signal generator configured to generate an optical pulse train, a coupler configured to split the optical pulse train into a first optical signal and a second optical signal, a sensor including a collimator configured to cause the second optical signal to be incident on the object at substantially a Brewster angle, and to receive the second optical signal reflected from a mirror and emitted through the object, and the mirror configured to reflect the second optical signal passing through the object to the object at substantially the Brewster angle, and a timing detector configured to output a timing error based on a phase difference between the first optical signal and the reflected second optical signal.

### CROSS-REFERENCE TO RELATED APPLICATIONS

This application claims the benefit of priority under 35 U.S.C. § 119 to Republic of Korea Patent Application No. 10-2025-0043284, filed Apr. 3, 2025, and Republic of Korea Patent Application No. 10-2025-0143685, filed Oct. 1, 2025, the contents of which are incorporated herein by reference in their entirety.

### BACKGROUND

### 1. Field of the Invention

The disclosure generally relates to a system for measuring a thickness of an object.

### 2. Description of the Related Art

Technologies for sensing objects using non-destructive inspection schemes such as vision inspection, interferometric inspection, X-ray inspection, and ultrasound inspection are being developed. The inspection schemes listed above may have their drawbacks. Vision inspection may have poor accuracy depending on reflectivity or lighting conditions, interferometric inspection may have limited depth-direction inspection accuracy, and X-ray and ultrasound inspection may have limited resolution. Therefore, an inspection technology with improved performance over existing sensing technologies may be required. The above description has been possessed or acquired by the inventor(s) in the course of conceiving the present disclosure and is not necessarily an art publicly known before the present application is filed.

### SUMMARY

An aspect of the disclosure may provide a system for measuring a thickness of an object.

According to an aspect, there is provided a system for measuring a thickness of an object, the system including an optical signal generator configured to generate an optical pulse train, a coupler configured to split the optical pulse train into a first optical signal and a second optical signal, a sensor including a collimator configured to cause the second optical signal to be incident on the object at substantially a Brewster angle, and to receive the second optical signal reflected from a mirror and emitted through the object, and the mirror configured to reflect the second optical signal passing through the object to the object at substantially the Brewster angle, and a timing detector configured to output a timing error based on a phase difference between the first optical signal and the reflected second optical signal.

A path of the second optical signal that is incident on the object from the collimator and extending to the mirror may be substantially the same as a path of the second optical signal reflected by the mirror and emitted toward the collimator through the object.

The second optical signal that is incident on the object from the collimator may be a P-polarized optical signal.

The optical signal generator may include a mode-locked laser (MLL).

The system may further include a circulator configured to transmit the second optical signal to the sensor and transmit the second optical signal to the timing detector.

The system may further include a balanced photodetector configured to output an electrical signal proportional to the timing error.

The system may further include a computing device configured to calculate a thickness of the object based on the electrical signal.

The system may further include a reference signal generator configured to generate a reference signal based on the first optical signal.

The timing detector may be configured to output a timing error based on a phase difference between the reference signal and the second optical signal.

According to an aspect, there is provided a system for measuring a thickness of an object, the system including an optical signal generator configured to generate an optical pulse train, a coupler configured to split the optical pulse train into a first optical signal and a second optical signal, a sensor configured to sense the second optical signal, wherein the sensor includes a first collimator configured to cause the second optical signal to be incident on the object at substantially a Brewster angle, and a second collimator configured to receive the second optical signal reflected from the object, and a timing detector configured to output a timing error based on a phase difference between the first optical signal and the reflected second optical signal.

The second optical signal incident on the object from the first collimator may be a P-polarized optical signal.

The optical signal generator may include a mode-locked laser (MLL).

The system may further include a balanced photodetector configured to output an electrical signal proportional to the timing error.

The system may further include a computing device configured to calculate the thickness of the object based on the electrical signal.

The system may further include a reference signal generator configured to generate a reference signal based on the first optical signal.

The timing detector may be configured to output a timing error based on a phase difference between the reference signal and the second optical signal.

Additional aspects of embodiments will be set forth in part in the description which follows and, in part, will be apparent from the description, or may be learned by practice of the disclosure.

According to an embodiment, the system may measure the thickness of an object. The effects of the system according to an embodiment are not limited to the effect mentioned above, and other effects not mentioned will be clearly understood by those skilled in the art from the description below.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a schematic structural diagram of a system;

FIG. 2 is a schematic diagram of a sensor;

FIG. 3 is a schematic diagram of a sensor;

FIG. 4 is a schematic structural diagram of a system;

FIG. 5 is a schematic diagram of a sensor; and

FIG. 6 is a schematic structural diagram of a system.

### DETAILED DESCRIPTION

Hereinafter, embodiments are described in detail with reference to the accompanying drawings. However, various modifications may be made to the embodiments, and the scope of the disclosure is not limited or restricted by the embodiments. It should be understood that all modifications, equivalents or substitutions to the embodiments are included within the scope of the disclosure.

The terms used in the embodiments are for descriptive purposes only and should not be construed as limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

In addition, when describing the embodiments with reference to the accompanying drawings like reference numerals refer to like components and a repeated description related thereto will be omitted. When describing an embodiment, if it is determined that a detailed description of a related known technology may unnecessarily obscure the gist of the embodiment, the detailed description will be omitted.

Additionally, terms such as first, second, A, B, (a), (b), and the like may be used herein to describe components. Each of these terminologies is not used to define an essence, order, or sequence of a corresponding component but used merely to distinguish the corresponding component from other component(s). When it is mentioned that one component is “connected” or “coupled” to, or “accessed” by another component, it may be understood that the one component is directly connected or coupled to, or accessed by another component or that still another component is interposed between the two components.

Components included in an embodiment and components that have common functions will be described using the same names in other embodiments. Unless otherwise stated, the description given for an embodiment may also be applied to other embodiments, and specific descriptions will be omitted to the extent of overlap.

In this document, terms such as “substantially,” “approximately,” “typically/generally,” and “about” when referring to a given parameter, property, or condition may include the extent to which one of ordinary skill in the art would understand that the given parameter, property, or condition is satisfied with a small degree of variance, such as within acceptable manufacturing tolerances. For example, any particular parameter that is substantially satisfied may be satisfied at least 90%, satisfied at least 95%, or satisfied at least 99%.

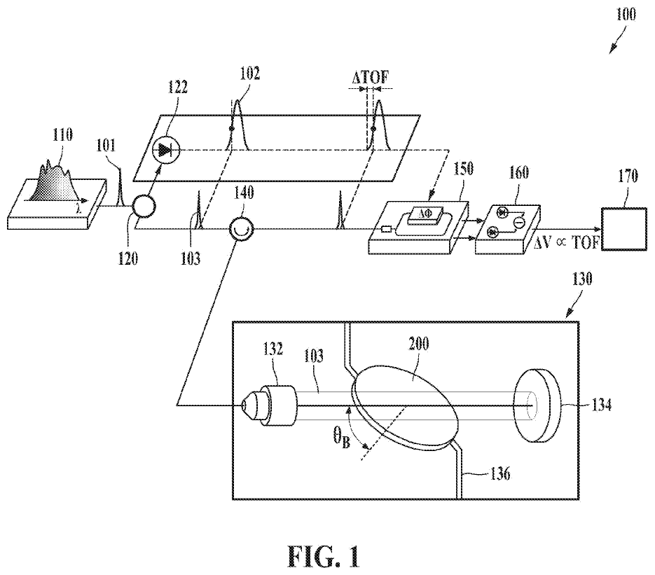

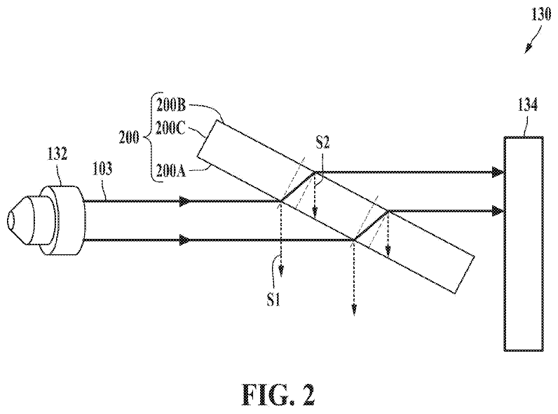

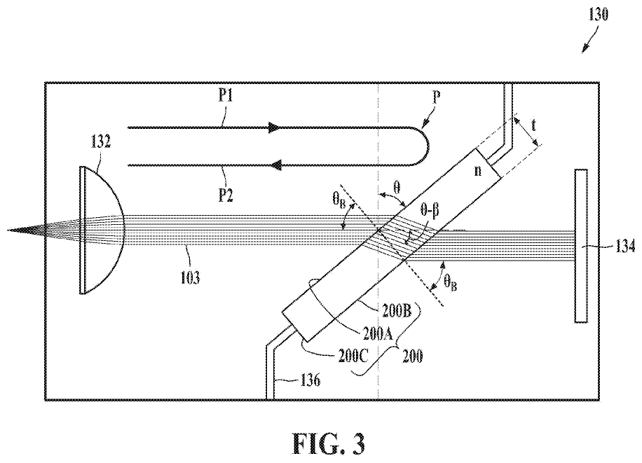

FIG. 1 is a schematic structural diagram of a system. FIG. 2 is a schematic diagram of a sensor. FIG. 3 is a schematic diagram of a sensor.

Referring to FIGS. 1 to 3, a system 100 may be configured to measure a thickness t of an object 200 (e.g., a transparent body). The system 100 may measure the thickness t of the object 200 through time-of-flight (TOF) measurement based on optical phase detection using a pulse laser. The system 100 may be configured to measure a pulse round trip distance within the object 200 based on TOF distance measurement based on electro-optic sampling (EOS). The system 100 may measure the thickness t of the object 200 based on the pulse round trip distance. The object 200 may include a first surface 200A, a second surface 200B opposite to the first surface 200A, and a side 200C between the first surface 200A and the second surface 200B, and the thickness t of the object 200 may be a dimension along which the side 200C extends between the first surface 200A and the second surface 200B.

The system 100 may include an optical signal generator 110 configured to generate an optical pulse train. The optical signal generator 110 may include a laser that generates an optical pulse train. For example, the laser included in the optical signal generator 110 may be a femtosecond laser that generates very short optical pulses on a femtosecond scale, a mode-locked laser (MLL), or an optical frequency comb laser. In addition to the laser, the optical signal generator 110 may further include a driving circuit, a power supply, and the like to stabilize a generated optical pulse train.

The system 100 may include a coupler 120 that splits an optical pulse train into a first optical signal and a second optical signal 103. The coupler 120 may be configured to separate an optical pulse train at a predetermined ratio (e.g., 1:1, 1:2, and the like) to generate the first optical signal and the second optical signal 103. The coupler 120 may be configured to guide the first optical signal to a path (e.g., a path toward a reference signal generator 122) with respect to which a reference signal 102 is generated, and to guide the second optical signal 103 to a path toward the object 200. The coupler 120 may have low-loss characteristics to minimize optical loss.

The system 100 may include the reference signal generator 122 that receives the first optical signal and generates the reference signal 102. The reference signal generator 122 may include a photodiode that converts an optical signal into an electrical signal. The reference signal generator 122 may generate a current pulse when the first optical signal is incident on the reference signal generator 122, and the generated current pulse may be the reference signal 102. The reference signal generator 122 may include a high-speed photodiode. However, the reference signal generator 122 is not limited thereto, and the reference signal generator 122 may include a conventional photodiode. When the reference signal generator 122 includes a high-speed photodiode, a current pulse having a steeper rising edge may be generated compared to when the reference signal generator 122 includes a conventional photodiode. High-speed photodiodes may have a shorter rise time of the current pulse, which may allow for more precise determination of an arrival time of an optical pulse and improve TOF measurement sensitivity of the entire system.

The system 100 may include a sensor 130 configured to direct the second optical signal 103 at the object 200 and sense an optical signal reflected back from a reflective member (e.g., a mirror 134). The sensor 130 may include a collimator 132 configured to direct the second optical signal 103 to the object 200 at substantially a Brewster angle Θ_{B}. The collimator 132 may be configured to cause the second optical signal 103 to be incident on the object 200 at substantially the Brewster angle Θ_{B}. The collimator 132 may be configured to receive the second optical signal 103 that is incident on the object 200 and then reflected (e.g., from the mirror 134) and emitted through the object 200. When the second optical signal 103 is incident on the object 200 at substantially the Brewster angle RB, reflection of a specific polarization component may be minimized and transmission may be maximized. The second optical signal 103 that is incident on the object 200 may be a P-polarized optical signal to minimize reflection of a specific polarization component and maximize transmission.

The system 100 may include the mirror 134 configured to reflect the second optical signal 103 passing through the object 200. The mirror 134 may be configured to reflect the second optical signal 103 to the object 200 at substantially the Brewster angle Θ_{B}. A path along which the second optical signal 103 reflected from the mirror 134 is emitted toward the collimator 132 through the object 200 may be substantially the same as a path of the second optical signal 103 that is incident on the object 200 from the collimator 132 and extends to the mirror 134.

Referring to FIG. 2, it may be understood that when the second optical signal 103 is incident on the object 200 at substantially the Brewster angle Θ_{B}, reflection of a specific polarization component is minimized and transmission is maximized. The second optical signal 103 directed to the object 200 by the collimator 132 may reach the first surface 200A. The second optical signal 103 that reaches the first surface 200A may be suppressed from being reflected as first reflected light S1, and substantially all of the second optical signal 103 that reaches the first surface 200A may pass through the first surface 200A. The second optical signal 103 that reaches the second surface 200B inside the object 200 may be suppressed from being reflected as second reflected light S2, and substantially all of the second optical signal 103 that reaches the second surface 200B may pass through the second surface 200B. The second optical signal 103 that passes through the object 200 may be directed to the mirror 134.

Referring to FIG. 3, when the second optical signal 103 is incident on the object 200 at substantially the Brewster angle Θ_{B}, a path P of the second optical signal 103 may be incident on the object 200 by the collimator 132, reflected by the mirror 134, and returned to the collimator 132. The second optical signal 103 reflected from the mirror 134 and directed to the collimator 132 may proceed along a second path P2. A first path P1, which is the path of the second optical signal 103 that is incident on the object 200 from the collimator 132 and extends to the mirror 134, may be substantially the same as the second path P2, which is a path of the second optical signal 103 that is reflected by the mirror 134 and emitted toward the collimator 132 through the object 200. The first path P1 and the second path P2 may share substantially the same optical path, and only the propagation directions of the optical signal may be opposite to each other.

When the second optical signal 103 is reflected from the mirror 134 and is incident on the object 200 at substantially the Brewster angle Θ_{B}, reflection of a specific polarization component may be minimized and transmission may be maximized. As described with reference to FIG. 2, when the second optical signal 103 is reflected from the mirror 134 and is incident on the object 200 at substantially the Brewster angle Θ_{B}, the second optical signal 103 that reaches the second surface 200B may be suppressed from being reflected, and substantially all of the second optical signal 103 that reaches the second surface 200B may pass through the second surface 200B. The second optical signal 103 that reaches the first surface 200A inside the object 200 may be suppressed from being reflected, and substantially all of the second optical signal 103 that reaches the first surface 200A may pass through the first surface 200A. The second optical signal 103 that passes through the object 200 may be directed to and be incident on the collimator 132.

The second optical signal 103 may travel back and forth along a single optical path along the first path P1 and the second path P2, and a time delay TOF₂-TOF₁ that occurs while traveling back and forth to the object 200 may be reflected in the second optical signal 103. The time delay TOF₂-TOF₁ may be the difference between a TOF (TOF₂) required for the second optical signal 103 to pass through the object 200 and travel back and forth to the sensor 130 and a TOF (TOF₁) required for the second optical signal 103 to travel back and forth to the sensor 130 without passing through the object 200. Unlike the case where the second optical signal 103 does not pass through the object 200, when the second optical signal 103 passes through the object 200, the path of the second optical signal 103 may be refracted in the process of passing through the object 200, and a lateral shift may be caused in the propagation direction of the second optical signal 103 so that the optical path increases, and the TOF (TOF₂) required for the second optical signal 103 to pass through the object 200 and travel back and forth to the sensor 130 may be greater than the TOF (TOF₁) required for the second optical signal 103 to travel back and forth to the sensor 130 without passing through the object 200. The thickness t of the object 200 may be calculated based on a rotation angle Θ of the object 200, which is an angle between the object 200 and a plane perpendicular to a propagation direction of the second optical signal 103 transmitted from the collimator 132, a refractive index no of air, a refractive index n of the object 200, an angle of refraction β given by Snell's law, and the time delay TOF₂-TOF₁, as expressed by Equation 1 below.

$${TOF}_{2} - {TOF}_{1} = \frac{2 t}{cos β} ( n - {n}_{0} cos ( θ - β ) ) \qquad [ Equation 1 ]$$

The sensor 130 may include a holder 136 configured to arrange and fix the object 200 such that the second optical signal 103 is incident on the object 200 at the Brewster angle Θ_{B}. The holder 136 may be configured to translate or rotate the object 200 so that a surface (e.g., the first surface 200A or the second surface 200B) of the object 200 has a predetermined angle of incidence with respect to the second optical signal 103. The holder 136 may rotate the object 200 so that the object 200 has a rotation angle Θ relative to a plane perpendicular to the propagation direction of the second optical signal 103 transmitted from the collimator 132. The second optical signal 103 may be incident on the object 200 rotated by the rotation angle Θ by the holder 136 at the Brewster angle Θ_{B}. The Brewster angle Θ_{B} may be 90 degrees minus the rotation angle Θ. The second optical signal 103 passing through the object 200 fixed by the holder 136 may penetrate the object 200 at the angle of refraction β given by Snell's law. The holder 136 may include a support frame to stably support the object 200. The holder 136 may be designed in an arbitrary shape that may rotate the object 200.

The system 100 may include a circulator 140 configured to transmit the second optical signal 103 transmitted from the coupler 120 to the sensor 130 and transmit the second optical signal 103 to a subsequent path (e.g., a timing detector 150). The circulator 140 may be configured to control the propagation direction of a signal to be unidirectional. The circulator 140 may cause a transmitted optical signal and a received optical signal to be processed independently without interfering with each other even when sharing the same path. For example, the second optical signal 103 may be input from the coupler 120 to a first port of the circulator 140, output from a second port, and transmitted to the sensor 130, and the second optical signal 103 returning from the sensor 130 may be input to a third port of the circulator 140 and transmitted to a subsequent path (e.g., the timing detector 150). The circulator 140 may be configured to maintain polarization characteristics of the second optical signal 103 that are input from the coupler 120 and pass through the object 200 at the Brewster angle Θ_{B}.

The system 100 may include the timing detector 150 configured to output a timing error based on a phase difference between the reference signal 102 and the second optical signal 103 transmitted from the sensor 130 (e.g., via the circulator 140). The timing detector 150 may output the timing error based on information regarding the time delay TOF₂-TOF₁ that occurs while the second optical signal 103 travels back and forth to the object 200. The timing detector 150 may detect a relative arrival time between the reference signal 102 and the second optical signal 103, and output the timing error indicating the time difference. The timing detector 150 may be based on a Sagnac loop interferometer. However, the timing detector 150 is not limited thereto, and various methods for EOS may be used. Although the timing detector 150 herein is described as outputting the timing error based on the reference signal 102 representing a current pulse generated from a high-speed photodiode, in another embodiment, the timing detector 150 may be configured to output the timing error based on the reference signal 102 representing a microwave generated from a voltage-controlled oscillator (VCO).

The system 100 may include a balanced photodetector 160 configured to output an electrical signal based on the timing error output from the timing detector 150. The balanced photodetector 160 may be configured to output an electrical signal (e.g., voltage) proportional to the timing error. For example, when the timing detector 150 is based on a Sagnac loop interferometer, an interference signal including information related to the timing error may be separated and input to the balanced photodetector 160, and the balanced photodetector 160 may output the difference in intensity of the interference signal as a voltage.

The system 100 may include a computing device 170 that calculates a thickness of the object 200 using the electrical signal (e.g., voltage) output from the balanced photodetector 160. The computing device 170 may include a processor, memory, a computational module, or an input/output interface, and may analyze the timing error reflected in the output voltage of the balanced photodetector 160 and calculate a TOF based on optical phase detection. The computing device 170 may calculate the thickness t of the object 200 based on information regarding the time delay TOF₂-TOF₁ and the refractive index n of the object 200 based on Equation 1.

Although the balanced photodetector 160 herein is described as a separate component from the timing detector 150, embodiments are not limited thereto, and the balanced photodetector 160 may be included in the timing detector 150 as a component of the timing detector 150. In another embodiment, the timing detector 150 may be configured to output a timing error and output an electrical signal based on the timing error.

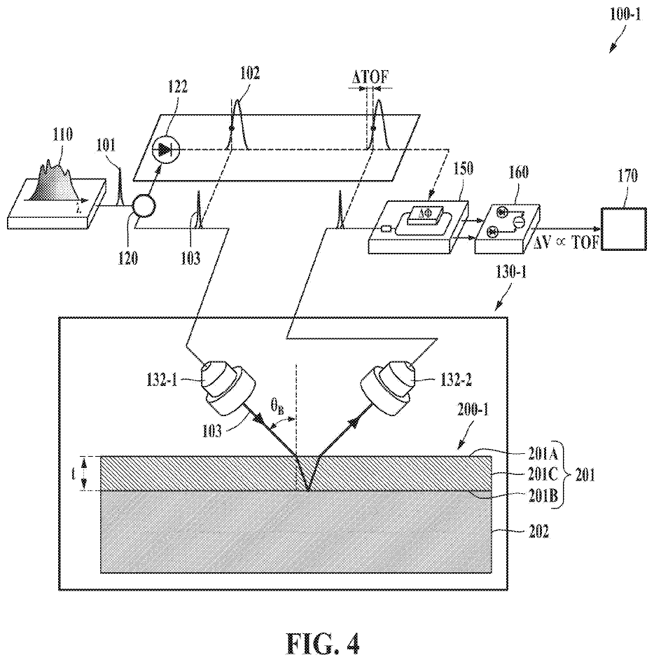

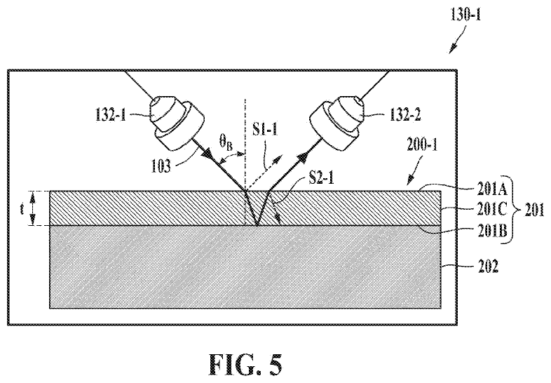

FIG. 4 is a schematic structural diagram of a system. FIG. 5 is a schematic diagram of a sensor.

Referring to FIGS. 4 and 5, a system 100-1 (e.g., the system 100 of FIG. 1) may be configured to measure a thickness t of an object 200-1 (e.g., the object 200 of FIGS. 1 to 3). The object 200-1 may include a thin film 201 and a substrate 202 below the thin film 201. The thin film 201 may include a first thin film surface 201A, a second thin film surface 201B opposite to the first thin film surface 201A and facing the substrate 202, and a thin film side 201C between the first thin film surface 201A and the second thin film surface 201B. In this disclosure, the thickness t of the object 200-1 may be a dimension in which the thin film side 201C extends between the first thin film surface 201A and the second thin film surface 201B, and may refer to the thickness t of the thin film 201. The substrate 202 may be configured to reflect an optical signal. For example, the substrate 202 may include a mirror.

The system 100-1 may include a sensor 130-1 that causes the second optical signal 103 to be incident on the object 200-1 and senses the second optical signal 103 reflected back from the object 200-1. The sensor 130-1 may include a first collimator 132-1 configured to cause the second optical signal 103 to be directed to the object 200-1 at substantially a Brewster angle Θ_{B}. The first collimator 132-1 may be configured to cause the second optical signal 103 to be incident on the object 200-1 at substantially the Brewster angle Θ_{B}. The second optical signal 103 incident on the object 200-1 may be a P-polarized optical signal to minimize reflection of a specific polarization component and maximize transmission.

Referring to FIG. 5, it may be understood that when the second optical signal 103 is incident on the object 200-1 at substantially the Brewster angle Θ_{B}, reflection of a specific polarization component is minimized and transmission is maximized. The second optical signal 103 directed to the object 200-1 by the first collimator 132-1 may reach the first thin film surface 201A. The second optical signal 103 that reaches the first thin film surface 201A may be suppressed from being reflected as first reflected light S1-1, and substantially all of the second optical signal 103 that reaches the first thin film surface 201A may pass through the first thin film surface 201A. The second optical signal 103 that reaches the second thin film surface 201B and/or the substrate 202 inside the object 200-1 may be reflected and reach the first thin film surface 201A again. The second optical signal 103 that reaches the first thin film surface 201A inside the thin film 201 may be suppressed from being reflected as second reflected light S2-1, and substantially all of the second optical signal 103 that reaches the first thin film surface 201A may pass through the first thin film surface 201A.

The system 100-1 may include a second collimator 132-2 configured to receive the second optical signal 103 reflected back from the object 200-1. The second collimator 132-2 may be disposed to be aligned with the propagation direction of the second optical signal 103. The second collimator 132-2 may directly receive the second optical signal 103 reflected from the object 200-1. The second collimator 132-2 may be configured to transmit the received second optical signal 103 to the timing detector 150. The second optical signal 103 transmitted to the timing detector 150 may reflect information regarding a time delay TOF₂-TOF₁ generated when the second optical signal 103 is incident on and reflected from the object 200-1. The timing detector 150 may detect a timing error based on the reference signal 102 and the time delay TOF₂-TOF₁.

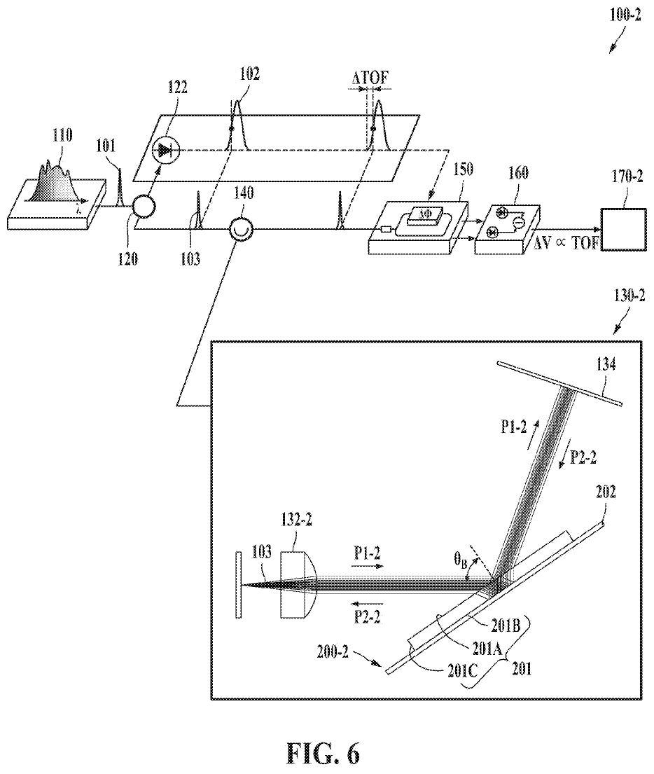

FIG. 6 is a schematic structural diagram of a system.

Referring to FIG. 6, a system 100-2 (e.g., the system 100 of FIG. 1 or the system 100-1 of FIG. 4) may be configured to measure a thickness t of an object 200-2 (e.g., the object 200 of FIGS. 1 to 3 or the object 200-1 of FIGS. 4 and 5). The object 200-2 may include the thin film 201 and the substrate 202 on the thin film 201. The thin film 201 may include the first thin film surface 201A, the second thin film surface 201B opposite to the first thin film surface 201A and facing the substrate 202, and the thin film side 201C between the first thin film surface 201A and the second thin film surface 201B. The thickness t of the object 200-2 may be a dimension by which the thin film side 201C extends between the first thin film surface 201A and the second thin film surface 201B, and may refer to the thickness of the thin film 201. The substrate 202 may be configured to reflect an optical signal. For example, the substrate 202 may include a mirror.

The system 100-2 may include a sensor 130-2 that causes the second optical signal 103 to be incident on the object 200-2 and senses the second optical signal 103 reflected back from the object 200-2. The sensor 130-2 may include a collimator 132-2 (e.g., the collimator 132 of FIGS. 1 to 3) configured to cause the second optical signal 103 to be directed to the object 200-2 at substantially a Brewster angle Θ_{B}. The collimator 132-2 may be configured to cause the second optical signal 103 to be incident on the object 200-2 at substantially the Brewster angle Θ_{B}. The second optical signal 103 incident on the object 200-2 may be a P-polarized optical signal to minimize reflection of a specific polarization component and maximize transmission. The collimator 132-2 may be configured to receive the second optical signal 103 that is incident on the object 200-2, reflected by the mirror 134, and then emitted through the object 200-2.

A first path P1-2 (e.g., the first path P1 of FIG. 3), which is a path of the second optical signal 103 that is incident on the object 200-2 from the collimator 132-2 and extends to the mirror 134, may be substantially the same as a second path P2-2 (e.g., the second path P2 of FIG. 3), which is a path of the second optical signal 103 that is reflected by the mirror 134 and emitted toward the collimator 132-2 through the object 200-2. The second optical signal 103 transmitted along the first path P1-2 may be directed toward the object 200-2 by the collimator 132-2 and reach the first thin film surface 201A. The second optical signal 103 that reaches the first thin film surface 201A may reach the second thin film surface 201B through the thin film side 201C. The second optical signal 103 that reaches the second thin film surface 201B may be reflected by the substrate 202, reach the first thin film surface 201A again through the thin film side 201C, and be directed to the mirror 134. The second optical signal 103 transmitted along the second path P2-2 after reaching the mirror 134 from the first thin film surface 201A may be directed toward the object 200-2 by the mirror 134 and reach the first thin film surface 201A. The second optical signal 103 that reaches the first thin film surface 201A may reach the second thin film surface 201B through the thin film side 201C. The second optical signal 103 that reaches the second thin film surface 201B may be reflected by the substrate 202, reach the first thin film surface 201A again through the thin film side 201C, and be directed to the collimator 132-2.

The second optical signal 103 travels back and forth along a single optical path along the first path P1-2 and the second path P2-2, and the time delay TOF₂-TOF₁ that occurs while traveling back and forth to the object 200-2 may be reflected in the second optical signal 103. When the thicknesses t of the objects 200, 200-1, and 200-2 are the same, the second optical signal 103 of FIG. 6 may be incident from the first thin film surface 201A to reach the second thin film surface 201B, reflected by the substrate 202, and reach the first thin film surface 201A again. Accordingly, the time delay TOF₂-TOF₁ reflected in the second optical signal 103 in the sensor 130-2 may be twice the time delay TOF₂-TOF₁ reflected in the second optical signal 103 in the sensor 130 of FIG. 1 or the sensor 130-1 of FIG. 4.

The system 100-2 may include a computing device 170-2 (e.g., the computing device 170 of FIG. 1 or FIG. 4) configured to calculate the thickness t of the object 200-2 from a time delay TOF₂-TOF₁ reflected in the second optical signal 103. The computing device 170-2 may calculate the thickness t of the object 200-2 using an electrical signal (e.g., voltage) output from the balanced photodetector 160, based on the second optical signal 103 reflecting the time delay TOF₂-TOF₁ generated by traveling back and forth on the first path P1-2 and the second path P2-2.

While this disclosure includes embodiments, it will be apparent to one of ordinary skill in the art that various changes in form and details may be made in these embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A system for measuring a thickness of an object, the system comprising:
an optical signal generator configured to generate an optical pulse train;
a coupler configured to split the optical pulse train into a first optical signal and a second optical signal;
a sensor, wherein the sensor comprises:
a collimator configured to cause the second optical signal to be incident on the object at substantially a Brewster angle, and to receive the second optical signal reflected from a mirror and emitted through the object; and
the mirror configured to reflect the second optical signal passing through the object to the object at substantially the Brewster angle; and
a timing detector configured to output a timing error based on a phase difference between the first optical signal and the reflected second optical signal.

2. The system of claim 1, wherein a path of the second optical signal that is incident on the object from the collimator and extending to the mirror is substantially the same as a path of the second optical signal reflected by the mirror and emitted toward the collimator through the object.

3. The system of claim 1, wherein the second optical signal that is incident on the object from the collimator is a P-polarized optical signal.

4. The system of claim 1, wherein the optical signal generator comprises a mode-locked laser (MLL).

5. The system of claim 1, further comprising:
a circulator configured to transmit the second optical signal to the sensor and transmit the second optical signal to the timing detector.

6. The system of claim 1, further comprising:
a balanced photodetector configured to output an electrical signal proportional to the timing error.

7. The system of claim 6, further comprising:
a computing device configured to calculate the thickness of the object based on the electrical signal.

8. The system of claim 1, further comprising:
a reference signal generator configured to generate a reference signal based on the first optical signal.

9. The system of claim 8, wherein the timing detector is configured to output a timing error based on a phase difference between the reference signal and the second optical signal.

10. A system for measuring a thickness of an object, the system comprising:
an optical signal generator configured to generate an optical pulse train;
a coupler configured to split the optical pulse train into a first optical signal and a second optical signal;
a sensor configured to sense the second optical signal, wherein the sensor comprises:
a first collimator configured to cause the second optical signal to be incident on the object at substantially a Brewster angle; and
a second collimator configured to receive the second optical signal reflected from the object; and
a timing detector configured to output a timing error based on a phase difference between the first optical signal and the reflected second optical signal.

11. The system of claim 10, wherein the second optical signal incident on the object from the first collimator is a P-polarized optical signal.

12. The system of claim 10, wherein the optical signal generator comprises a mode-locked laser (MLL).

13. The system of claim 10, further comprising:
a balanced photodetector configured to output an electrical signal proportional to the timing error.

14. The system of claim 13, further comprising:
a computing device configured to calculate the thickness of the object based on the electrical signal.

15. The system of claim 10, further comprising:
a reference signal generator configured to generate a reference signal based on the first optical signal.

16. The system of claim 15, wherein the timing detector is configured to output a timing error based on a phase difference between the reference signal and the second optical signal.
